(19) United States
(12) Patent Application Publication
(10) Pub. No.: US 2024/0425720 A1
(43) Pub. Date: Dec. 26, 2024

(54) (METH)ACRYLATE COMPOUNDS AS REACTIVE DILUENTS FOR POLYADDITION SYSTEMS

(71) Applicant: SIKA TECHNOLOGY AG, Baar (CH)

(72) Inventors: Burkhard WALTHER, Oldenburg (DE); Christian BRUCHERTSEIFER, Oldenburg (DE); Olaf JANSSEN, Oldenburg (DE)

(73) Assignee: SIKA TECHNOLOGY AG, Baar (CH)

(21) Appl. No.: 18/692,900

(22) PCT Filed: Oct. 26, 2022
(86) PCT No.: PCT/EP2022/080018

§ 371 Date: Mar. 18, 2024

(30) Foreign Application Priority Data
Oct. 27, 2021 (EP) 21204940.7

(51) Int. Cl. C09D 175/08; C08G 18/08; C08G 18/22; C08G 18/32; C08G 18/44; C08G 18/48; C08G 18/80; C08K 3/22; C08K 9/06; C09D 7/61; C09D 7/80

(52) U.S. Cl. CPC C09D 175/08; C08G 18/0842; C08G 18/0885; C08G 18/222; C08G 18/3209; C08G 18/44; C08G 18/4854; C08G 18/8012; C08K 3/22; C08K 9/06; C09D 7/61; C09D 7/80; C08K 2003/2206

(57) ABSTRACT

A coating composition includes an isocyanate compound, an isocyanate-reactive compound, a reactive diluent with (meth)acrylate functionality, optionally a carbon dioxide scavenger and an autooxidation catalyst. Moreover, a method prepares a reactive composition of an isocyanate compound with an isocyanate-reactive compound by adding a reactive diluent with (meth)acrylate functionality, optionally a carbon dioxide scavenger and an autooxidation catalyst. Finally, acrylates and/or methacrylates are used as reactive diluents for the reaction of an isocyanate compound with an isocyanate-reactive compound in the presence of an autooxidation catalyst and optionally a carbon dioxide scavenger.

The present invention relates to a coating composition comprising an isocyanate compound, an isocyanate-reactive compound, a reactive diluent with (meth)acrylate functionality, optionally a carbon dioxide scavenger and an autooxidation catalyst. Moreover, the present invention relates to a method for preparing a reactive composition of an isocyanate compound with an isocyanate-reactive compound by adding a reactive diluent with (meth)acrylate functionality, optionally a carbon dioxide scavenger and an autooxidation catalyst. Finally, the present invention relates to the use of acrylates and/or methacrylates as reactive diluents for the reaction of an isocyanate compound with an isocyanate-reactive compound in the presence of an autooxidation catalyst and optionally a carbon dioxide scavenger.

Polyurethanes and polyureas are widely applied polymer families. These polymers are used for shoes, mattresses, automotive parts, sports equipment, artificial leather and the like. Also, in construction chemistry they are most widely applied materials, e.g. for sealants, adhesives, coatings and foams in areas like mining, roofing, flooring, tile fixing, and waterproofing, to name a few. The high resistance to acids, alkalis and chemicals of the cured compositions obtained in this way are advantageous.

However, construction systems based on such reactive resins frequently having high viscosities. Adjustment of this to applicable viscosities is usually done by plasticizers and/or solvents. Plasticizers reduce the mechanical properties and frequently cause a greasy film on top of the coatings; solvents are causing VOC and smell. Moreover, the reactive starting materials of these resins often react much too fast, thus resulting in a very small open or pot lifetime. Dilution with solvents and/or plasticizers yet causes the aforementioned negative effects.

WO 2019/219503 A1 discloses (abstract) a reactive composition for making a polyisocyanurate-polyurethane comprising rigid foam (PIR-PUR), said reactive composition comprising a polyisocyanate composition, an isocyanate-reactive composition, at least one catalyst compound suitable for making the PIR-PUR comprising foam, at least one blowing agent; and optionally one or more surfactants, one or more flame retardants, one or more antioxidants, or combinations thereof characterized in that the reactive composition further comprises a reactive viscosity reducer selected from at least one acrylate and/or methacrylate compound having no isocyanate-reactive groups and having a viscosity at 25° C. below 100 mPa s. According to embodiments, the reactive composition further comprises a (peroxide-type) thermal radical initiator to initiate the (meth)acrylate polymerization.

In contrast thereto, the composition of the present invention does not form a rigid PIR-PUR foam and does not need a blowing agent. Moreover, the compound with vinyl functionality does not only adjust the viscosity of the reactive composition but also serves as a reactive diluent, thus prolonging the open-time of the composition and accelerating the drying time thereof. Finally, the composition of the present invention dries without a thermal radical initiator but under the influence of an autooxidation catalyst on contact with air.

EP 1557455 A1 discloses (abstract) reactive compositions with at least one compound A with at least two reactive groups, which are selected from the group comprising isocyanate, epoxide, alkoxysilane and mixtures thereof, and at least a polymeric thixotropic agent B, which is produced by a homopolymerization of a (meth)acrylates B1 or by a copolymerization of a (meth)acrylate B1 with at least one further (meth)acrylate, the (meth)acrylate mixture having an average (meth)acrylate functionality f from 2.5 to 4.5. The (meth)acrylate B1 therein has three or more (meth)acrylate groups. The invention also discloses the use of compound B as a thixotropic agent. (In contrast thereto, the vinyl compound according to the present invention is not added in polymeric form, but will polymerize in the course of the application of the reactive resin.)

GB 836 398 A discloses the blending of styrene and cobalt naphthenate with an OH-terminated prepolymer of a diisocyanate and castor oil and an NCO-terminated castor oil prepolymer. The present invention, in contrast, uses (meth)acrylates instead of styrene and does not use OH-terminated prepolymers.

RU 2233859 C2 (machine translation) discloses in the Examples mixtures comprising a polyisocyanate, water, cobalt naphthenate, an oligoether acrylate and Portland cement. The autooxidation catalysts of the present invention are based on Mn, Cu and Fe. Moreover, the carbon dioxide scavenger according to the present invention is selected from calcium hydroxide, calcium oxide and mixtures thereof.

U.S. Pat. No. 4,125,487 A discloses (Example 1) a composition comprising styrene, polyoxyethylene glycol, polymeric polyphenyl isocyanate, tert.-butyl perbenzoate and cobalt naphthenate. The present invention, in contrast, uses (meth)acrylates instead of styrene and does not use cobalt naphthenate and tert.-butyl perbenzoate.

WO 92/03483 A 1 discloses in Examples 1-4 mixtures of acrylates, polyols, isocyanates and iron (1+) complexes. These iron (1+) complexes are, however, used as photooxidation catalysts.

EP 0344910 A2 discloses in Examples 6 and 7 mixtures comprising methyl acrylate, polyethylene glycol, hexamethylene diisocyanate and an iron (1+) complex. This iron (1+) complex is, however, used as a photooxidation catalyst.

EP 0344911 A2 discloses in Examples 5 and 6 mixtures comprising methyl acrylate, polyethylene glycol, hexamethylene diisocyanate and an iron (1+) complex. Again, this iron (1+) complex is used as a photooxidation catalyst.

EP 0476822 A2 discloses in claim 1 a pressure-sensitive adhesive comprising at least one free-radically photopolymerized component, at least one photopolymerized polyurethane component, at least one organometallic complex salt initiator, and at least one free-radical initiator. The present invention, in contrast, does not use photopolymerization.

WO 93/19108 A 1 discloses in Examples 3, 5-8 mixtures comprising acrylates, an iron (1+) complex, a polyol and a polyisocyanate. In contrast to the present invention, curing is effected by peroxides.

U.S. Pat. No. 5,225,498 A discloses (Example 3) a combination of a polyether polyol, a diisocyanate, an epoxy vinyl ester polymer, a peroxide and cobalt naphthenate. In contrast, the present invention employs (meth)acrylates as reactive diluents, different autooxidation catalysts and does not use peroxides.

The contents of the cited documents are incorporated by reference herewith in their entirety.

It was an object of the present invention to essentially avoid at least some of the disadvantages described above. More particularly, it was the object of the present invention to find reactive diluents that polymerize in a 2^{nd} curing reaction after application of the system so that neither evaporation nor migration nor plasticizing effects would occur. Finally, it was the object of the present invention to find reactive diluents that would reduce the viscosity of the composition while prolonging the open-time and/or accelerating the drying of the composition. Thermal radical initiators such as peroxides should be avoided.

These objects have been achieved with the features of the independent claims. The dependent claims pertain to preferred embodiments.

It has been surprisingly found that compounds with (meth)acrylate functionality having no isocyanate-reactive groups, and being selected from acrylates, methacrylates and mixtures thereof, are very useful reactive diluents for the above mentioned reactive resins reducing the viscosity of the composition while prolonging the open-time and/or accelerating the drying time of the composition.

According to a first aspect, the present invention provides a coating composition comprising
(A) an isocyanate compound having ≥2 —NCO groups;
(B) an isocyanate-reactive compound having ≥2 isocyanate-reactive groups;
(C) a reactive diluent having no isocyanate-reactive groups and being selected from acrylates, methacrylates and mixtures thereof;
(D) a carbon dioxide scavenger if the reaction of (A) and (B) liberates carbon dioxide;
(E) an autooxidation catalyst; and
(F) optionally further catalysts and additives,
   wherein the autooxidation catalyst (E) is selected from transition metal compounds, wherein the transition metal is selected from Mn, Fe and Cu.

US 2012/0010357 A1 discloses in claim 1 a process for preparing a radiation-curable, high-functionality, highly branched or hyperbranched polyurethane (meth)acrylate, comprising: (i) preparing an adduct comprising one or more isocyanate groups and at least one isocyanate-reactive group by reaction of at least one first isocyanate compound and at least one compound having isocyanate reactive groups, . . . and (iv) reaction with an isocyanate reactive (meth)acrylate compound comprising at least one isocyanate-reactive group and at least one (meth)acrylate group. Moreover, US 2012/0010357 A1 discloses in Example 1 a system wherein the methacrylate compound does not contain an isocyanate-reactive group. Still, the adduct comprises isocyanate groups and isocyanate-reactive groups. In consequence, the resulting polyurethane should be highly branched or hyperbranched. Finally, no curing of this system is described.

In contrast thereto, the reaction product of (A) with (B) according to the present invention is not supposed to contain any isocyanate-reactive groups, and also the reactive diluent (C) is not supposed to contain any isocyanate-reactive groups. The reaction product of (A) with (B) according to the present invention is neither a highly branched nor a hyperbranched polyurethane (meth)acrylate. No stepwise addition of different isocyanates is necessary according to the present invention. Moreover, US 2012/0010357 A1 requires radiation-curing while curing of the reactive diluent (C) according to the present invention is effected by the presence of an autooxidation catalyst (E).

It should be noted that the coating composition of the present invention is a shelf-stable composition. Upon storage, the composition is protected from oxygen, i.e. does not contain (substantial amounts of) oxygen. Preferably, a stabilizer is present in the shelf-stable composition. Suitable and widely used antioxidation agents are 2,6-bis(t-butyl-) hydroxytoluene (BHT) and hydroquinone monomethylether (MEHQ). Only when the composition is applied to a surface, the stabilizer is used up and the autooxidation catalyst, upon contact with excess oxygen, will catalyze the polymerization reaction of the reactive diluent.

The term “shelf-stable” within the meaning of the present invention denotes a stability of the coating compositions of the invention which allows for a shelf life or storage time of at least 6 weeks, preferably at least 7 weeks, more preferably at least 8 weeks, e.g. at least 3 months, at least 6 months, and in particular at least 12 months.

“% b.wt.”, as used herein, means percent by weight, based on the total weight of the respective composition or formulation.

The isocyanate compound according to the present invention is an aliphatic isocyanate, an aromatic isocyanate or a combined aliphatic/aromatic isocyanate, having an —NCO functionality of ≥2.

Suitable isocyanates include tetramethylene diisocyanate, hexamethylene diisocyanate (HDI), dodecamethylene diisocyanate, 3-isocyanatomethyl-3,5,5-trimethylcyclohexyl isocyanate i.e. isophorone diisocyanate (IPDI), 4,4′-dicyclohexylmethane diisocyanate (H12MDI), 1,4-cyclohexane diisocyanate (CHDI), 4,4′-diisocyanatodicyclohexyl-2,2-propane, p-phenylene diisocyanate, 2,4- and 2,6-toluene diisocyanate (TDI) or mixtures thereof, tolidine diisocyanate (toluidine diisocyanate), 2,2′-, 2,4′- and 4,4′-diphenylmethane diisocyanate (MDI) or mixtures thereof, 1,2-naphthylene diisocyanate, xylylene diisocyanate, tetramethylxylene diisocyanate (TMXDI), and mixtures thereof.

Isocyanates containing heteroatoms in the moiety linking the isocyanate groups are also suitable, i.e. polyisocyanates containing urea groups, urethane groups, biuret groups, allophanate groups, uretidinedione groups, isocyanurate groups, imide groups, carbodiimide groups, uretonimine groups and the like. So-called “prepolymers” are also suitable, which prepolymers are reaction products of isocyanates with suitable polyols (described hereinbelow under isocyanate-reactive compounds), provided that these prepolymers still have an —NCO functionality of ≥2. Moreover, the isocyanates according to the present invention should not contain polymerizable double bonds. Also, no stepwise addition of different isocyanates with different reactivities is necessary according to the present invention.

It is preferred to use TDI, monomeric, oligomeric and/or polymeric isocyanates based upon diphenylmethane diisocyanate isomers (MDI), the so-called MDI-grades. Moreover, it is also preferred to use trimeric HDI having an isocyanurate group in the molecule.

The isocyanate-reactive compound comprises one or more isocyanate-reactive compounds having ≥2 isocyanate-reactive groups or water. An isocyanate-reactive group is a group having at least one isocyanate-reactive active hydrogen atom.

Isocyanate-reactive compounds can be selected from, but are not limited to, polyols, polyfunctional amines, carboxylic acids, particularly di-and tri-carboxylic acids, and water. Preferably, polyols, polyfunctional amines and water are suitable. In case of one-component isocyanate systems, atmospheric water can suffice.

A polyol is a polyfunctional alcohol having an —OH functionality of ≥2. Suitable polyols include, but are not limited to (poly)ethylene glycol, (poly)(1,2-propylene glycol), (poly)(1,3-propylene glycol), (poly)(2-methyl-1,3-propane diol), (poly)(1,2-butane diol), (poly)(1,3-butane diol), (poly)(1,4-butane diol) and (poly)(2,3-butane diol), (poly)(1,6-hexane diol), (poly)(1,8-octane diol), (poly)(neopentyl glycol), (poly)(cyclohexane dimethanol), (poly)(cyclohexane-1,4-diol), (poly)(1,4-bishydroxymethyl cyclohexane), (poly)(1,5-pentane diol), (poly)(3-methyl-1,5-pentane diol), (poly)(1,12-dodecane diol), diethylene glycol, triethylene glycol, tetraethylene glycol, pentaethylene glycol, dipropylene glycol, dibutylene glycol; glycerol, sorbitol, trimethylolpropane, 1,2,4-butane triol, 1,2,6-hexane triol, pentaerythritol, polyester polyols from aliphatic and/or aromatic sources such as polycaprolactones, adipates, terephthalate esters, polycarbonates, polyether polyols including polyethylene glycol, polypropylene glycol, polytetramethylene glycol (all of which are possible starting materials for prepolymers having an —NCO functionality of ≥2). Also suitable are polyhydroxylated natural oils and their derivatives, such as modified castor oil. In addition, mixtures of said compounds may be used. The term “(poly)”, as written in parentheses, stands for monomeric, oligomeric and/or polymeric compounds.

A polyfunctional amine is an amine with a functionality of ≥2. The amine component may be either linear or branched. The skeleton of the amine component may contain aliphatic, aromatic, aliphatic-aromatic, cycloaliphatic and heterocyclic structures. The amine function itself is aliphatic, i.e. the nitrogen is not part of an aromatic ring. Preferred polyfunctional amines are amino functionalized polyalkylene glycols, such as, for example, the Jeffamines® from Huntsman Corp., e.g. the Jeffamines D-230, D-400, D-2000, D-4000, T-403, T-3000, T-5000, ED-600, ED-2003, or amines of the general formula H₂N—(CH₂CH₂—NH)ₘ—CH₂CH₂—NH₂, where m=1 to 10, such as, for example, diethylenetriamine. Polymers which are selected from polyamines, dendritic polyamines, polyimines (such as, for example, the polyethyleneimines of the Lupasol® type from BASF SE), polyamides, polyaminoamides, polyurethanes, polyvinylamines or mixtures thereof are preferred as the polyfunctional amine component.

None of the isocyanate-reactive compounds should contain polymerizable double bonds. As mentioned above, the reaction product of (A) with (B) according to the present invention is not supposed to contain any isocyanate-reactive groups. This may be effected by using a suitable excess of (A). In other words, the reaction of (A) with (B) is to be conducted in such a way that the reaction product of (A) with (B) will not contain any isocyanate-reactive groups.

The reactive diluent is selected from acrylates, methacrylates and mixtures thereof.

The reactive diluent is preferably selected from mono-, di- or polyfunctional acrylic esters, mono-, di- or polyfunctional methacrylic esters, and mixtures thereof, preferably esters with polyols (as defined hereinabove).

The amount of reactive diluent may be in the range of from 0.1% b.wt. to 50% b.wt., preferably in the range of from 0.5 b.wt. to 35%, b.wt., more preferably in the range of from 1% b.wt. to 20% b.wt., calculated based on the total weight of the composition.

(Meth)acrylates having one reactive (meth)acrylate group may be selected from compounds such as 3,3,5-trimethyl cyclohexyl acrylate (TMCHA), isobornyl acrylate (IBOA), 4-tert-butylcyclohexyl acrylate (TBCHA), benzyl acrylate (BZA), and phenol (EO) acrylate (PHEA); benzyl methacrylate (BZMA), phenoxyethyl methacrylate (PHEMA), tetrahydrofurfuryl methacrylate (THFMA), and isobornyl methacrylate (IBOMA).

(Meth)acrylates having 2 or 3 reactive (meth)acrylate groups may be selected from compounds such as 1,6-hexanediol diacrylate (HDDA), hydroxy pivalic acid neopentyl glycol diacrylate (HPNDA), tripropylene glycol diacrylate (TPGDA), dipropylene glycol diacrylate (DPGDA), triethylene glycol diacrylate (TEGDA), and tetraethylene glycol diacrylate (TTEGDA); 1,6-hexanediol dimethacrylate (HDDMA), 1,4-butanediol dimethacrylate (BDDMA), neopentyl glycol dimethacrylate (NPGDMA), ethylene glycol dimethacrylate (EGDMA), diethylene glycol dimethacrylate (DEGDMA), triethylene glycol dimethacrylate (TREGDMA), tetraethylene glycol dimethacrylate (T4EGDMA), and polyethylene glycol 200 dimethacrylate (PEG200DMA), and 1,2- or 1,4-cyclohexanediol dimethacrylate.

As mentioned above, the reactive diluent (C) is not supposed to contain any isocyanate-reactive groups. In other words, the reactive diluent will not become chemically bound to the polyurethane or polyamine chain. Instead, the reactive diluent will independently polymerize upon contact with air (oxygen) by means of the autooxidation catalyst (E).

All carbon dioxide scavengers that are commonly used as carbon dioxide scavengers in polyurethane-type polymers can be used. Suitably, the carbon dioxide scavenger is selected from hydroxides, oxides, silicates, and aluminates of alkaline earth metals, in particular hydroxides such as calcium hydroxide, and oxides such as calcium oxide. A preferred carbon dioxide scavenger is calcium oxide.

The optional catalysts that may be present in the composition of the invention are catalysts for the isocyanate/water reaction and the isocyanate/polyol reaction.

The isocyanate-catalyzing catalyst can be any compound that catalyzes the reaction of the isocyanate component. Suitable catalysts include organometallic catalysts and tertiary amine compounds. Suitable amine compounds include trialkyl amines such as triethylamine, tripropylamine, tributylamine and derivatives of trialkyl amines including, without limitation, 2-(dimethylamino)ethanol and other dialkyl alkanolamines such as 2-[2-(Dimethylamino) ethoxy] ethanol, bis(2-dimethylaminoethyl)ether and 2,2′-dimorpholinodiethylether (DMDEE). A particularly preferable tertiary amine compound is triethylenediamine (1,4-diazabicyclo[2.2.2]octane, DABCO). Preferred organometallic catalysts include tin based, zinc based, strontium based and bismuth based catalysts. A preferred tin-based catalyst is dibutyltin dilaurate (DBTL). Preferred bismuth based and zinc based catalysts include carboxylic acid salts of bismuth and zinc, such as bismuth tris 2-ethylhexanoate.

The autooxidation catalyst is an essential constituent of the composition of the present invention. It is a catalyst that upon contact with air (or any other source of oxygen) will start the radical polymerization of the (meth)acrylate groups. Among catalysts effective in oxidative drying of (meth)acrylates are particularly those based on Cu, Mn and Fe. Such catalysts are generally useful and effective at levels of about 0.1% by weight, based on the overall composition or formulation. Cure of (meth)acrylates also occurs with catalysts based on Co, Zn, Zr, Li and V. Preferred, however, are transition metal compounds wherein the transition metal is selected from Mn, Fe and Cu.

One major advantage of these autooxidation catalysts is that thermal radical initiators, light and/or peroxides can be completely avoided and the composition can be stored in one-component form (as long as it is dry, oxygen-free, and optionally stabilized with stabilizers such as BHT). Upon contact with oxygen, the autooxidation catalyst will initiate the radical polymerization of the (meth)acrylate groups, thus leading to a shortened drying time of the composition. The composition of the present invention may be held available in one component or in two components, as well.

According to a second aspect, the present invention provides a process for preparing the coating composition of the present invention, comprising providing
(A) an isocyanate compound having ≥2 —NCO groups and
(B) an isocyanate-reactive compound having ≥2 isocyanate-reactive groups, and adding
(C) a reactive diluent having no isocyanate-reactive groups and being selected from acrylates, methacrylates and mixtures thereof,
(D) a carbon dioxide scavenger if the reaction of (A) and (B) liberates carbon dioxide, and
(E) an autooxidation catalyst,
   wherein the autooxidation catalyst (E) is selected from transition metal compounds, wherein the transition metal is selected from Mn, Fe and Cu.

According to a further aspect, the invention provides a process for preparing the coating composition of the invention, comprising the steps of
(A) providing an isocyanate compound having ≥2 —NCO groups,
(B) providing an isocyanate-reactive compound having ≥2 isocyanate-reactive groups,
(C) providing a reactive diluent having no isocyanate-reactive groups and being selected from acrylates, methacrylates and mixtures thereof,
(D) providing a carbon dioxide scavenger if the reaction of (A) and (B) liberates carbon dioxide, and
(E) providing an autooxidation catalyst, and
(F) mixing the components (A) to (E),
   wherein the autooxidation catalyst (E) is selected from transition metal compounds, wherein the transition metal is selected from Mn, Fe and Cu.

The sequence of providing and mixing the components (A) to (E) can be technically executed in orders different to the order given in the above process definitions. For instance, (A) and (B) can be first mixed and the other components can be subsequently added thereto and mixed. The coating composition can be formulated as a one-component formulation or as a two-component formulation. For instance, the isocyanate component (A) (sometimes also referred to as “Part B”) may be provided separately from the other components (B)-(E) (sometimes also collectively referred to as “Part A”). Both Parts should then be mixed shortly before the application of the coating composition.

According to a third aspect, the present invention provides for the use of acrylates and/or methacrylates having ≥1 acrylate and/or methacrylate groups and having no isocyanate-reactive groups, as reactive diluents for the reaction of an isocyanate compound (A) having ≥2 —NCO groups and an isocyanate-reactive compound (B) having ≥2 isocyanate-reactive groups, in the presence of a carbon dioxide scavenger (D) if the reaction of (A) and (B) liberates carbon dioxide, and an autooxidation catalyst (E), wherein the autooxidation catalyst (E) is selected from transition metal compounds, wherein the transition metal is selected from Mn, Fe and Cu.

The present invention will be further illustrated by the following non-limiting examples.

### EXAMPLES

### Example 1

65.55% b.wt. (i.e. percent by weight, based on the total weight of the composition) of HDI trimer (Desmodur N 3600, Covestro AG), 16.60% b.wt. of triethylene glycol dimethacrylate (TEGDMA, Sartomer SR 205H, Sartomer Arkema), 0.42% b.wt. of iron (1+)-chloro-[dimethyl-9,9-dihydroxy-3-methyl-2,4-di-(2-pyridinyl-kN)-7-[(2-pyridinyl-kN)methyl]-3,7-diazabicyclo[3.3.1]nonane-1,5-dicarboxylate-kN3, kN7]-chloride(1−) (CAS No.: 478945-46-9, in 1,3 propanediol, hereinafter called “Borchi-Oxy-Coat 1410”, Borchers GmbH), 0.83% b.wt. of 2,2′-dimorpholinodiethylether (DMDEE, Jeffcat DMDEE/PC CAT, Huntsman Performance Chemicals), and 16.60% b.wt. of calcium oxide dispersion (A: surface-modified CaO dispersion, B: Byk 2616, Altana) were mixed. The same compositions, but without the methacrylate and without the iron catalyst, were also mixed (79% HDI trimer, 1% DMDEE, 20% CaO dispersion).

Viscosities were measured after mixing via speed mixer for 1 min at 1000 rpm. The one-component systems were applied at room temperature with a 1000 μm squeegee (“Rakel”) on polypropylene sheets. Drying was done at 23° C. at 50% relative humidity (standard climate). The results are given in Table 1 (for the surface-modified calcium oxide dispersion A) and Table 2 (for the calcium oxide dispersion B).

TABLE 1

| | With Methacrylate | Without Methacrylate |
|---|---|---|
| Viscosity [mPa s] at 23° C. | 500 | 1000 |
| Dry to touch time [h] | 4 | 6 |

TABLE 2

| | With Methacrylate | Without Methacrylate |
|---|---|---|
| Viscosity [mPa s] at 23° C. | 900 | 1400 |
| Dry to touch time [h] | 8 | 16 |

From Table 1 and 2, it can be seen that the effect of the reactive diluent results in a viscosity reduction as well as a shortened drying time of the applied coat.

### Example 2

Part A: 55.0% b.wt. of polytetramethylene ether glycol polyol 650 (CAS No.: 25190 Jun. 1, PTMEG 650, BASF SE), 20.0% b.wt. of triethylene glycol dimethacrylate (TEGDMA, Sartomer SR 205H, Sartomer Arkema), 1.0% b.wt. of Lutensol® AO3 (non-ionic surfactant, BASF SE), 20,0% b.wt. of water, 2.0% of lithium neodecanoate (Duroct Lithium, 2% NDA (neodecanoic acid), DURA Chemicals, Inc), 1.0% b.wt. of 2,2′ dimorpholinodiethylether (DMDEE, Jeffcat DMDEE/PC CAT, Huntsman Performance Chemicals), and 1.0% of Borchi-Oxy-Coat 1410 (Borchers GmbH). Part B: 80.0% b.wt. of HDI trimer (Desmodur N 3600, Covestro AG), and 20% b.wt. of calcium oxide dispersion (Byk 2616, Altana). 25 parts b.wt. of Part A and 75 parts b.wt. of Part B were mixed. The same compositions, but without the methacrylate and without the iron catalyst, were also mixed (Part A: 69.62% PTMEG 650, 25.32% water, 1.27% Lutensol, 1.27% DMDEE, and 2.52% lithium neodecanoate).

Viscosities were measured after mixing via speed mixer for 1 min at 1000 rpm. The mixtures were applied at room temperature with a 1000 μm squeegee (“Rakel”) on polypropylene sheets. Drying was done at 23° C. at 50% relative humidity (standard climate). The results are given in Table 3.

TABLE 3

| | With Methacrylate | Without Methacrylate |
|---|---|---|
| Viscosity [mPa s] at 23° C. | 270 | 260 |
| Pot life-time until solid [h] | >4 | >4 |
| Dry to touch time [h] | 16 | >48 |

From Table 3, it can be seen that the effect of the reactive diluent results in an accelerated drying time. The pot lifetimes were too short to measure a difference. There was not much difference in terms of viscosities.

### Example 3

A different polyol was used. Part A: 79.3% b.wt. polycarbonate diol 2000 mw (CAS No.: 92538-66-4, Desmophen C 1200, Covestro AG), 20.0% b.wt. triethylene glycol dimethacrylate (TEGDMA, Sartomer SR 205H, Sartomer Arkema), 0.2% b.wt. dibutyltin dilaurate (Cosmos 19, Evonik AG), and 0.5% b.wt. Borchi-Oxy-Coat 1410 (Borchers GmbH), and Part B: HDI trimer (Desmodur N 3600, Covestro AG) were mixed (100 parts b.wt. of Part A and 15 parts b.wt. of Part B). The same compositions, but without the methacrylate and without the iron catalyst, were mixed (Part A: 99.75% polycarbonate diol, 0.25% dibutyltin dilaurate; 100 parts A: 19 Part B).

Viscosities were measured after mixing via speed mixer for 1 min at 1000 rpm. The mixtures were applied at room temperature with a 1000 μm squeegee (“Rakel”) on polypropylene sheets. Drying was done at 23° C. at 50% relative humidity (standard climate). The results are given in Table 4.

TABLE 4

| | With Methacrylate | Without Methacrylate |
|---|---|---|
| Viscosity [mPa s] at 23° C. | 4200 | 15900 |
| Pot life-time until solid [h] | 5.5 | 3 |
| Dry to touch time [h] | 0.5 | 0.5 |

From Table 4, it can be seen that the effect of the reactive diluent results in an extended pot lifetime. The drying times were too short to measure a difference. The viscosity was much lower with the methacrylate than without it.

### Example 4

Another isocyanate compound was tested. 70.9% of an IPDI prepolymer (made from IPDI, Evonik AG, and a polyetherpolyol mixture (Desmophen 3600Z, Desmophen 1600U), Covestro AG) were mixed with 8.0% of a latent hardener (bisoxazolidine, Incorez Ltd.). 20.0% b.wt. of triethylene glycol dimethacrylate (TEGDMA, Sartomer SR 205H, Sartomer Arkema), 0.5% b.wt. of Borchi-Oxy-Coat 1410 (Borchers GmbH), 0.1% dibutyl-tin dilaurate (DBTDL, Cosmos 19, Evonik AG) and 0.5% b.wt. of 2,2′-dimorpholinodiethylether (DMDEE, Jeffcat DMDEE/PC CAT, Huntsman) were added and mixed. The same compositions, but without the methacrylate and without the iron catalyst, were also mixed (i.e. 91.4% IPDI prepolymer, 8.0% latent hardener, 0.1% Cosmos 19, 0.5% DMDEE).

TABLE 5

| | With Methacrylate | Without Methacrylate |
|---|---|---|
| Viscosity [mPa s] at 23° C. | 8900 | 12600 |
| Dry to touch time [h] | <16 | >16 |

It can be seen from Table 5 that the composition with reactive diluent and autooxidation catalyst had a much lower viscosity and a faster drying time.

### Example 5

Different autooxidation catalysts were tested. In the following Table 6, “Cu-TMEDA” stands for di-μ-hydroxo-bis-[(N,N,N′,N′-tetramethyl ethylenediamine)-copper (II)] chloride solution, 0.2% in triethylphosphate (Sigma-Aldrich). “Deca Mn. 8 HS” stands for manganese decanoate (Borchers GmbH). “Borchi OxyCoat” is the above mentioned Borchi-Oxy-Coat 1410 (Borchers GmbH).

1.0% of the respective catalyst was used in a composition of 76.0% poly THF (Poly THF 650, BASF SE), 20.0% TEGDMA (Sartomer SR 205H, Sartomer Arkema), 2.0% lithium neodecanoate (Duroct Lithium, 2% NDA, DURA Chemicals, Inc) and 1.0% b.wt. 2,2′ dimorpholinodiethylether (DMDEE, Jeffcat DMDEE/PC CAT, Huntsman). 100 parts b.wt. of the former composition were mixed with 43 parts b.wt. of HDI trimer (Desmodur N 3600, Covestro AG) and tested for viscosity, pot life-time and drying time. The first run was done without the methacrylate and without the autooxidation catalyst, the other runs were done with the methacrylate and the respective catalyst. The results are indicated in Table 6. Borchi OxyCoat lead to a lower pot life-time at unchanged drying times.

TABLE 6

| | w/o | Borchi | | Deca Mn. |
|---|---|---|---|---|
| | Methacrylate | OxyCoat | Cu-TMEDA | 8 HS |
| Viscosity | 400 | 290 | 290 | 270 |
| [mPa s] at 23° C. | | | | |
| Pot life-time | 0.25 | 0.5 | 2.0 | 2.0 |
| Dry to touch | 15 | 15 | 15 | 15 |
| time [h] | | | | |

### Example 6

Different autooxidation catalysts were used. Example 3 was repeated with manganese (2+) neodecanoate (“Mn”) and with copper (2+) neodecanoate (“Cu”) as catalysts instead of Borchi-Oxy-Coat 1410.

TABLE 7

| | | With | Without |
|---|---|---|---|
| Catalyst | | Methacrylate | Methacrylate |
| Mn | Viscosity [mPa s] at 23° C. | 4200 | 15900 |
| | Pot life-time until solid [h] | 5.75 | 3 |
| | Dry to touch time [h] | 0.75 | 0.5 |
| Cu | Viscosity [mPa s] at 23° C. | 4200 | 15900 |
| | Pot life-time until solid [h] | 5.4 | 3 |
| | Dry to touch time [h] | 0.75 | 0.5 |

The results were essentially the same as with Borchi-Oxy-Coat 1410, as can be seen from Table 5 above. Although there is a slight increase in drying time this is offset by the large improvement in pot life-time and the reduction of starting viscosity.

### Example 7

Different reactive diluents were tested. In the following Table 8, “Sartomer SR 239EU” stands for 1,6-hexanediol dimethacrylate, “Sartomer SR 210HH” is a polyethylene glycol dimethacrylate (PEG200DMA) grade, “Sartomer SR 350D” is trimethylolpropane trimethacrylate, all from Sartomer Arkema, and “Laromer LR 8887” is a monofunctional acrylic acid ester of trimethylolpropane from BASF SE.

Part A: 79.3% b.wt, of polycarbonate diol 2000 mw (CAS No.: 92538-66-4, Desmophen C 1200, Covestro AG), 20.0% b.wt. of the respective reactive diluent, 0.2% b.wt. of dibutyltin dilaurate (Cosmos 19, Evonik AG), and 0.5% b.wt. of Borchi-Oxy-Coat 1410 (Borchers GmbH), and Part B: HDI trimer (Desmodur N 3600, Covestro AG) were mixed (100 parts b.wt. of Part A and 15 parts b.wt. of Part B). The results were consistent.

TABLE 8

| Part A: | | | | | |
|---|---|---|---|---|---|
| Desmophen C 1200 | 79.3 | 79.3 | 79.3 | 79.3 | 79.3 |
| Sartomer SR 205H | 20 | | | | |
| Sartomer SR 239EU | | 20 | | | |
| Sartomer SR 210HH | | | 20 | | |
| Sartomer SR 350D | | | | 20 | |
| Laromer LR 8887 | | | | | 20 |
| Cosmos 19 | 0.2 | 0.2 | 0.2 | 0.2 | 0.2 |
| Borchi OxyCoat 1410 | 0.5 | 0.5 | 0.5 | 0.5 | 0.5 |
| Part B: | | | | | |
| Desmodur N 3600 | | | | | |
| B:A Ratio | 15:100 | 15:100 | 15:100 | 15:100 | 15:100 |
| Viscosity | 3920 | 3610 | 4290 | 7100 | 5610 |
| [mPa s] at 23° C. | | | | | |
| Dry to touch time [min] | 48 | 45 | 45 | 42 | 50 |

1. A coating composition comprising
(A) an isocyanate compound having ≥2 —NCO groups;
(B) an isocyanate-reactive compound having ≥2 isocyanate-reactive groups;
(C) a reactive diluent having no isocyanate-reactive groups and being selected from acrylates, methacrylates and mixtures thereof;
(D) a carbon dioxide scavenger if the reaction of (A) and (B) liberates carbon dioxide;
(E) an autooxidation catalyst; and
(F) optionally further catalysts and additives,
wherein the autooxidation catalyst (E) is selected from transition metal compunds, wherein the transition metal is selected from Mn, Fe and Cu.

2. The composition of claim 1, wherein the isocyanate compound (A) is selected from the group consisting of an aliphatic isocya-nate, an aromatic isocyanate or a combined aliphatic/aromatic isocyanate which is selected from difunctional isocyanates, trifunctional isocyanates or polyfunctional isocyanates, from monomeric, dimeric, trimeric or oligomeric isocyanates, and mixtures thereof.

3. The composition of claim 1, wherein the isocyanate compound (A) is selected from TDI, trimeric HDI and monomeric and/or oligomeric MDI, and mixtures thereof.

4. The composition of claim 1, wherein the isocyanate-reactive compound (B) is selected from polyols, polyfunctional amines, and water.

5. The composition of claim 1, wherein the reactive diluent is selected from mono, di- or polyfunctional acrylic esters, mono, di- or polyfunctional methacrylic esters, and mixtures thereof.

6. The composition of claim 1, wherein the reactive diluent is in the range of from 0.1% b.wt. to 50% b.wt., calculated on the total weight of the composition.

7. The composition of claim 1, wherein the carbon dioxide scavenger (D) is selected from calcium hydroxide, calcium oxide and mixtures thereof.

8. The composition of claim 1, wherein the optional catalyst (F) is selected from catalysts for the isocyanate/water reaction and/or the isocyanate/polyol reaction.

9. The composition of claim 1, which is held available in one component or in two components.

10. A process for preparing the coating composition of claim 1, comprising the steps of
(A) providing an isocyanate compound having ≥2 —NCO groups,
(B) providing an isocyanate-reactive compound having ≥2 isocyanate-reactive groups,
(C) providing a reactive diluent having no isocyanate-reactive groups and being selected from acrylates, methacrylates and mixtures thereof,
(D) providing a carbon dioxide scavenger if the reaction of (A) and (B) liberates carbon dioxide, and
(E) providing an autooxidation catalyst, and
(F) mixing the components (A) to (E),
wherein the autooxidation catalyst (E) is selected from transition metal compounds, wherein the transition metal is selected from Mn, Fe and Cu.

11. A method comprising using acrylates and/or methacrylates having ≥1 acrylate and/or methacrylate groups and having no isocyanate-reactive groups, as reactive diluents for the reaction of an isocyanate compound (A) having ≥2 —NCO groups and an isocyanate-reactive com-pound (B) having ≥2 isocyanate-reactive groups, in the presence of a carbon dioxide scavenger (D) if the reaction of (A) and (B) liberates carbon dioxide, and an autooxidation catalyst (E), wherein the autooxidation catalyst (E) is selected from transition metal compounds, wherein the transition metal is selected from Mn, Fe and Cu.
